(19) United States
(12) Patent Application Publication
(10) Pub. No.: US 2007/0113391 A1
(43) Pub. Date: May 24, 2007

(54) Modular assembly line with a pallet with a frame adjustable for a specific workpiece and methods of adjusting and position finding

(76) Inventors: Pertti Tykkylainen, Kontiolahti (FI); Jussi Karaiste, Joensuu (FI)

Correspondence Address: YOUNG & THOMPSON, 745 SOUTH 23RD STREET, 2ND FLOOR, ARLINGTON, VA, 22202, US

(21) Appl. No.: 11/240,418

(22) Filed: Oct. 3, 2005

Related U.S. Application Data
(63) Continuation of application No. PCT/FI04/00186, filed on Mar. 30, 2004.

(30) Foreign Application Priority Data
Apr. 1, 2003 (FI) 20030487

(51) Int. Cl. B23Q 17/00

(52) U.S. Cl. 29/407.09

(57) ABSTRACT

A method of adjusting an assembly line, and a positioning unit. The positioning unit comprises a fixing member of a lower support plate and an upper support plate. Further, the assembly line has conveying means conveying workpieces to the positioning unit and away from it. The fixing member of the lower support plate and the fixing member of the upper support plate are manufactured in such a way that the locations of a workpiece-specific lower support plate and a workpiece-specific upper support plate are determined unambiguously in the corresponding fixing member. The fixing member of the lower support plate is aligned with the fixing member of the upper support plate, and said fixing members are fixed permanently in place.

### BACKGROUND OF THE INVENTION

The invention relates to a method of adjusting a modular assembly line, the assembly line comprising at least one positioning unit, the positioning unit comprising a fixing member of a lower support plate and a fixing member of an upper support plate, which are arranged movably relative to each other in such a way that the fixing member of the lower support plate is transferable to a first and a second distance relative to the fixing member of the upper support plate; an actuator arranged in connection with the positioning unit, operating a tool used in the working step taking place in the positioning unit; and conveyor means, which comprise pallets conveying workpieces, and a conveyor, the conveyor means conveying workpieces to the positioning unit and away from it.

Further, the invention relates to a positioning unit of a modular assembly line.

Still further, the invention relates to a computer program, which is loadable into the internal memory of a digital computer, and to a computer program product.

Electronic devices, such as mobile phones, are most often assembled on automatic or semiautomatic assembly lines. It is typical that the batch sizes ordered by clients vary a lot. Therefore, the intention is to design an assembly line to be modular in such a way that several different products can be assembled on it by changing, as a rule, only product-specific parts and settings. Thus, the product change time, i.e. the time it takes to change one product assembled on an assembly line to another product, constitutes a significant cost factor. The product change time significantly affects the utilization degree of the assembly line, and in this respect, the competitiveness of the assembling company.

An assembly line most often comprises several assembly devices, and conveyor means that convey workpieces from one assembly device to another. An assembly device comprises a positioning unit in which the workpieces conveyed by the conveyor means are lifted out of the conveyor means for the time of the working step performed by the assembly device. Briefly, the positioning unit functions in such a way that the workpieces usually enter the positioning unit as pallets, brought by a conveyor. A pallet is stopped at the point of the positioning unit, and the workpieces on the pallet are lifted out of the pallet and against an upper support plate shaped for the specific workpiece. The lifting is carried out with a lower support plate made according to the workpiece. The workpieces are positioned between the lower and upper support plates. Subsequently, an actuator belonging to the assembly device performs the working step. After the working step, the workpieces are lowered back to the pallet, supported by the lower support plates. The pallet moves to the following working step on the conveyor.

The product change of an assembly line is presently carried out as follows:

1. The lower support plate is adjusted in such a way relative to the stopped pallet that the pieces can be lifted up from the pallet.

2. The upper support plate is adjusted in such a way relative to the lower support plate that the workpiece is correctly positioned between the support plates.

3. The lifting height of the lower support plate is adjusted in such a way that the workpiece is appropriately pressed between the support plates.

4. The perpendicularity of the upper support plate and the lower support plate is adjusted by machining the fixing plate of the lower support plate.

5. The coordinate systems of the actuator and the workpiece are fitted together by teaching the workpiece points to the actuator.

There are some problems in the above-described product change. Firstly, the change of the workpiece-specific support plates and tools as well as the mechanical and software-based fine adjustment of the devices of the assembly line consume a great deal of resources and time: depending on the size of the line, they take from one person-workweek to several person-workweeks. The product change time is long, because both the upper and lower support plates are adjusted. Further, the adjustment work and the resulting location of the workpiece in the coordinate system of the actuator vary according to the skill and aptitude of the person carrying out the adjustment. Adjusting is based on experimentation and the experience of the person carrying out the adjustment. Since the location of the workpiece most probably changes in the product change in an unexpected manner, the actuator must be taught in connection with each product change separately. Furthermore, if the lower support plate has to be machined to correct the perpendicularity, the whole adjustment must be started from the beginning after the machining.

### BRIEF DESCRIPTION OF THE INVENTION

An object of the present invention is to provide a novel and an improved method of adjusting a modular assembly line, and a positioning unit of a modular assembly device, in which above-described problems are avoided.

The method according to the invention is characterized by manufacturing the fixing member of the lower support plate in such a way that the location of a workpiece-specific lower support plate is unambiguously determined in the fixing member in question; manufacturing the fixing member of the upper support plate in such a way that the location of a workpiece-specific upper support plate is unambiguously determined in the fixing member in question; aligning the fixing member of the lower support plate with the fixing member of the upper support plate and fixing said fixing members permanently to their places aligned in this manner; aligning the conveyor means with said fixing members of the upper and lower support plates; and fixing the coordinate system of the actuator and the coordinate system of the positioning unit to each other.

Further, the positioning unit according to the invention is characterized in that it comprises:
a frame, a fixing member of a lower support plate arranged in the frame, a fixing member of an upper support plate arranged in the frame and movably in direction X relative to the fixing member of the lower support plate in such a way that the fixing member of the lower support plate is transferable to a first and a second distance relative to the fixing member of the upper support plate;
fixing parts arranged in the fixing member of the lower support plate for fixing a product-specific lower support plate unambiguously to the fixing member;
fixing parts arranged in the fixing member of the upper support plate for fixing a product-specific upper support plate unambiguously in the fixing member, which fixing members of the lower support plate and upper support plate are arranged in the frame immovably in the directions perpendicular to direction X.

Further, the computer program according to the invention is characterized in that said computer program comprises a software code for teaching product-specific parameters to an intelligent actuator of a positioning unit in the coordinate system of the positioning unit provided by the method according to claim 1.

Still further, the computer program product according to the invention is characterized in that it comprises a computer program according to claim 12.

An essential idea of the invention is that the location of the workpiece, i.e. the location of the lower and upper support plates, is always the same and known in the coordinate system of the actuator.

An advantage of the invention is that the task of the assembly device, i.e. the workpiece handled or the measure taken therein, can be changed without adjusting the positioning unit, whereby the product change time can be made significantly shorter.

The essential idea of a preferred embodiment of the invention is that each workpiece located on the pallet and thus to be handled at a time has in the positioning unit an upper support plate of its own, which can change its position in the direction of movement X of the lower support plate irrespective of the other upper support plates of the same positioning unit. An advantage is that lower and upper support plates of each workpiece are pressed against each other throughout, even if all lower and upper support pairs were not completely perpendicular to each other.

### BRIEF DESCRIPTION OF THE FIGS

The invention will be explained in greater detail in the attached drawings, of which

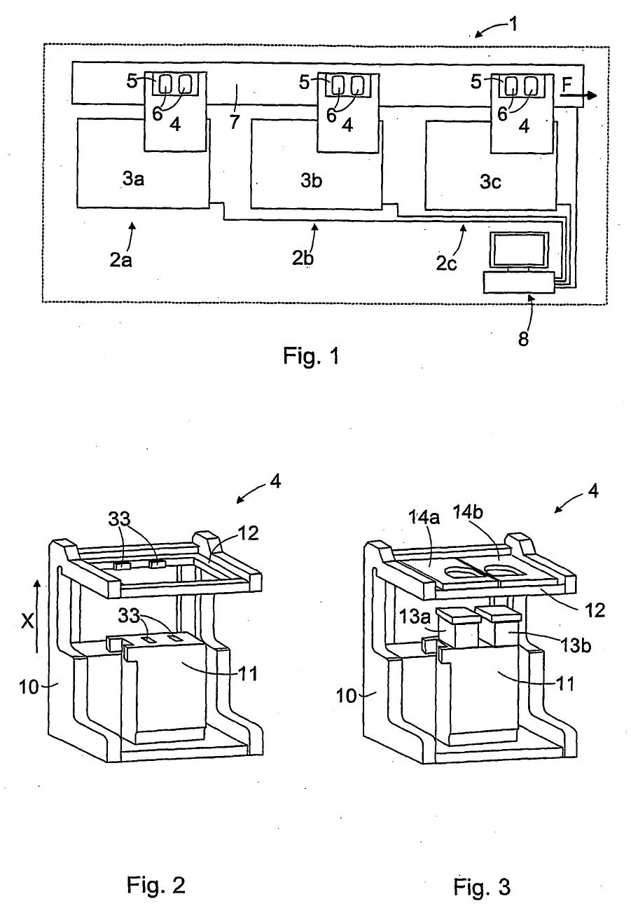

FIG. 1 shows schematically a modular assembly line comprising positioning units according to the invention;

FIG. 2 shows schematically a positioning unit according to the invention;

FIG. 3 shows schematically a positioning unit according to FIG. 2, to which product-specific upper and lower support plates are fixed;

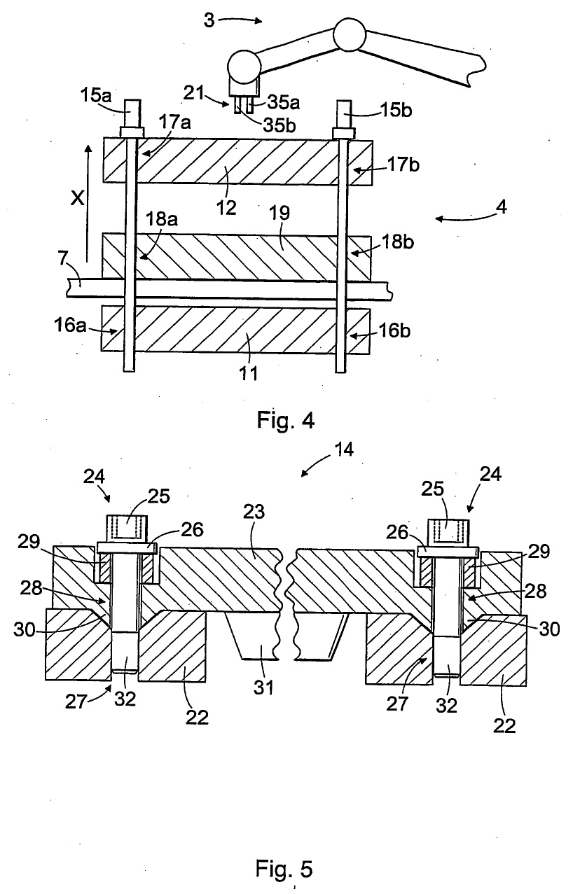

FIG. 4 shows schematically a method according to the invention in the alignment step of the lower and upper support plates and the conveyor means; and

FIG. 5 shows schematically a side view of an upper support plate used in the positioning unit according to the invention.

For the sake of clarity, the invention is shown simplified in the figures. Similar parts are denoted with the same reference numerals.

### DETAILED DESCRIPTION OF THE INVENTION

FIG. 1 shows schematically a modular assembly line comprising positioning units according to the invention. The assembly line 1 comprises three assembly devices 2a, 2b, 2c altogether. Each assembly device has an intelligent actuator 3a, 3b, 3c for carrying out a given task. An intelligent actuator—hereinafter ‘actuator’—refers in this description to an actuator for which a coordinate system can be determined and to which parameters and points bound to this coordinate system can be taught, by means of which parameters and points a tool, e.g. gripper, operated by the actuator 3a, 3b, 3c, is aligned with the workpiece during the task. The actuator 3a, 3b, 3c is, for example, a robot, a manipulator or the like.

The assembly device 2a, 2b, 2c further comprises a positioning unit 4 that is preferably similar in each assembly device 2a, 2b, 2c. The positioning unit 4 comprises a lower support plate and an upper support plate, which are described in more detail later.

Further, the assembly line 1 comprises workpiece conveyor means, which convey workpieces 6 from one positioning unit 4 to another. The main parts of the conveyor means are a pallet 5 and a conveyor 7. The workpieces 6, which are cover parts of a mobile phone, for example, are arranged on pallets 5. The pallet 5 has one or more workpieces 6—the pallet of FIG. 1 has two workpieces—arranged in such a way that each workpiece 6 is in a determined position and at a determined point on the pallet 5. The conveyor 7 is arranged to move pallets 5 to the positioning units 4 and out of them. The direction of movement of the pallets 5 is shown by arrow F in the figure. The type of the conveyor 7 is, for example, a narrow-belt conveyor, a two-belt conveyor or the like. It is essential in the conveyor 7 that an unoccupied space remains under the pallet 5, from which the workpieces can be lifted up by means of a lower support plate.

The assembly process of the assembly line 1 is controlled with a control system 8 comprising a digital computer. In the internal memory of the computer, there are loaded a computer program or programs including for example product-specific parameters of a software code for controlling the intelligent actuators 3a, 3b, 3c, and a software code needed in controlling the conveyor 7.

FIG. 2 shows schematically a positioning unit according to the invention, and FIG. 3 shows schematically the positioning unit according to FIG. 2, having product-specific upper and lower support plates fixed to it. The positioning unit 4 is universal, in other words it has changeable product-specific parts. By changing the product-specific parts, the positioning unit 4 can be used in handling different workpieces.

The positioning unit comprises a frame 10, which, in turn, comprises fixing members 11 of the lower support plate and fixing members 12 of the upper support plate 12. The fixing members 11 of the lower support plate are arranged movably in direction X relative to the frame 10 but substantially immovably in the directions perpendicular relative to this direction. The fixing members 11 of the lower support plate move guided by guide tracks, for example, and the force providing the movement is generated for instance electrically, hydraulically or pneumatically.

The fixing members 11, 12 of the lower support plate and the upper support plate are aligned in directions perpendicular to direction X, and fixed to their places aligned in this way. The fixing is implemented unambiguously in such a way that after the fixing the location of the fixing members 11 of the lower support plate is not adjustable or changeable relative to the fixing member 12 of the upper support plate. The fixing is implemented for instance by welding, riveting, a screw joint or the like reliable fixing method. The length of the movement in direction X is also arranged unambiguously, in other words the length of the movement is not adjustable after the arrangement.

The fixing member 11 of the lower support plate, as also the fixing member 12 of the upper support plate, comprises fixing parts 33 with which product-specific support plates 13a, 13b and 14a, 14b are fixed.

In FIG. 3, two lower support plates 13a, 13b and corresponding two upper support plates 14a, 14b are detachably fixed to the fixing members 11, 12 of the lower and upper support plates. There are two pairs of lower and upper support plates, because each pallet 5 to be handled in the positioning unit 4 comprises two workpieces. Thus, all workpieces of the pallet 5 can be handled with one single movement of the fixing members 11 of the lower support plate.

The lower and upper support plates 13a, 13b and 14a, 14b are designed in such a way that they keep the workpiece 6 pressed between them in place when the actuator 3a, 3b, 3c performs the task directed at the workpiece in question. The piece-specific lower and upper support plates 13a, 13b and 14a, 14b represent the prior art known per se, and therefore they are not described in greater detail here.

The fixing parts 33 of the fixing members 11,12 of the lower and upper support plates and the lower and upper support plates 13a, 13b and 14a, 14b themselves are manufactured in such a way that each support plate 13a, 13b and 14a, 14b is unambiguously fixed to the corresponding fixing member 11, 12. In other words, the location of the support plate 13a, 13b and 14a, 14b in the fixing member 11, 12 is not adjustable. The fixing can be implemented in such a way, for example, that the location of the support plates 13a, 13b and 14a, 14b is aligned with cotter bolts, the actual fixing being carried out with screws, wedges, magnets or the like openable joints.

The lower and upper support plates 13a, 13b and 14a, 14b are workpiece-specific components. When the product to be assembled on the assembly line 1 changes or when the task of the assembly device 2a, 2b, 2c changes, the lower and upper support plates 13a, 13b and 14a, 14b that have been used are replaced with the lower and upper support plates 13a, 13b and 14a, 14b needed in the handling of the new workpiece or task.

FIG. 4 shows schematically a method according to the invention in the alignment step of the lower and upper support plates and the conveyor means. The alignment is carried out as follows.

First, the fixing member 11 of the lower support plate of the positioning unit 4 is aligned with the fixing member 12 of the upper support plate by means of auxiliary tools 15a, 15b. The auxiliary tool 15a, 15b is in the embodiment of FIG. 4 an elongated, rigid bar having a round cross-section. The embodiment of the method shown in FIG. 4 utilizes two auxiliary tools 15a, 15b, but the number of auxiliary tools may naturally be something else. In addition, it is to be noted that the cross-section of the auxiliary tool does not necessarily have to be round. Two first alignment surfaces 16a, 16b are arranged in the fixing member 11 of the lower support plate, and correspondingly, two second alignment surfaces 17a, 17b are arranged in the fixing member 12 of the upper support plate. The first and the second alignment surfaces 16a, 16b and 17a, 17b are in this embodiment round holes piercing the fixing member. The alignment surfaces 16a, 16b and 17a, 17b are arranged in such a way that when the auxiliary tools 15a, 15b can be arranged simultaneously on the alignment surfaces 16a, 17a of both fixing members 11, 12, the fixing members 11, 12 are aligned with each other. In addition, the fixing members 11, 12 are then parallel with each other. After this, the fixing members 11, 12 are fixed permanently to these places, after which their locations relative to each other cannot be adjusted any longer. In this connection, also the lifting height of the fixing member 11 of the lower support plate is adjusted, and it is fixed in such a way that it cannot be adjusted after this.

Next, the conveyor means are aligned with the positioning unit 4. This is carried out in such a way that the auxiliary pallet 19 used in the alignment is stopped in the positioning unit 4. The auxiliary pallet 19 comprises two third alignment surfaces 18a, 18b. In the presented embodiment, these surfaces are round holes piercing the auxiliary pallet 19. The holes of the third alignment surfaces 18a, 18b are positioned in the auxiliary pallet 19 in such a way that the conveyor means are aligned correctly relative to the positioning unit when the auxiliary tool 15a, 15b can be arranged simultaneously through these holes and the holes formed by the first and second auxiliary surfaces 16a, 16b and 17a, 17b. At the same time, the conveyor means are parallel relative to the fixing members of the lower and upper support plates. The positioning unit 4 is fixed to the location thus aligned in such a way relative to the conveyor means that its location cannot be changed. The positioning unit 4 can be fixed for instance with screws to a table board known per se, not shown in the figures.

The auxiliary pallet 19 may be an ordinary pallet 5 used in conveying workpieces and comprising the required third alignment surfaces 18a, 18b, or it may be a special tool used merely for adjustment.

In aligning conveyor means, it may not be necessary to use the same auxiliary tools as when aligning the fixing members 11, 12. Instead, auxiliary tools for conveyor means can be used that are arranged on the third auxiliary surfaces 18a, 18b and that are intended to be used only for aligning conveyor means with the fixing members 11, 12 of either the lower or the upper support plate or both.

As the third step, the coordinate system of the actuator 3 is fixed to the coordinate system of the positioning unit 4. This is carried out in such a way, for example, that the actuator 3 is provided with a teaching tool 21, which is moved from one point of the workpiece pressed between the support plates to another. The teaching tool 21 preferably comprises two pins 35a, 35b arranged at a distance from each other, whereby not only the location of the point but also the angle of the teaching tool 21 is found out. The points to be taught may also be positioned in the fixing plate 12 of the upper support plate, for instance. The movements of the teaching tool 21 are stored in the memory of the control system 8 controlling the actuator.

The above steps are carried out in the first assembly of the positioning unit 4, i.e. when the universal positioning unit 4 is manufactured. The steps need not be performed in a case of product or task change, in other words when product-specific lower and upper support plates 13a, 13b and 14a, 14b are fixed to the positioning unit. In a case of product or task change, the only thing to do is to fix the required lower and upper support plates to the fixing members. Separate adjustment is not performed, because the location of the support plates is unambiguous and the location of the workpiece in the coordinate system of the actuator is always the same.

The advantage that can be achieved with the invention is represented by the fact that in a prior art product change the product change time is about 16 hours. Utilizing the invention results in a product change time of about 15 minutes. The invention reduces the product change to an extremely simple event: detaching the old product-specific upper and lower support plates from the positioning unit and replacing them with product-specific upper and lower support plates required by the new workpiece. No adjustment is required.

Preferably, the tool designer determines as early as at the designing stage of the upper and lower support plates the parameters required by the actuator 3, in other words where the workpiece 6 is positioned relative to the positioning unit 4 and the tool used by the actuator 3. The support plates 13a, 13b and 14a, 14b can be positioned extremely accurately, whereby the accuracy of the operation of the positioning unit 4 depends only on the accuracy of manufacture of the upper and lower support plates 13a, 13b and 14a, 14b. The actuator 3 is provided with information on three points with which the coordinate system can be determined. Further, the actuator can be provided with information on those paths of movement that it must follow in the working step, or other information relating to the working step or workpiece.

In connection with the product change, the required product-specific upper and lower support plates 13a, 13b and 14a, 14b and the computer program code to be executed in a processor of the control system 8 are provided. The computer program code can be transferred to the control system 8 from an external memory means, such as a CD-ROM. It can also be transferred via a telecommunications network, for instance by connecting the control unit 8 via a wireless access network to the Internet. It is also feasible to use a hardware implementation or a combination of hardware and software solutions.

FIG. 5 shows schematically a side view of an upper support plate used in the positioning unit according to the invention. The upper support plate 14 comprises a frame 22, by which the upper support plate 14 is fixed to the fixing members 12 of the upper support plate. It is to be noted that the fixing members are not shown in FIG. 5. Further, the upper support plate 14 comprises a counterpart 23, which is provided with product-specific surfaces 31 shaped according to the workpiece to be handled and the requirements of the task.

The frame 22 and counterpart 23 of the upper support plate are attached to each other with fixing members 24, which in the embodiment of FIG. 5 comprise an Allen bolt 25, a retaining plate 26 and an elastic part 29. The threaded part 32 of the bolt 25 is arranged through the fixing hole 28 of the counterpart in such a way that the retaining plate 26 is under the bolt head, the elastic part 29 being between the retaining plate 26 and the counterpart 23. The threaded part 32 is locked in a threaded hole 27 formed in the frame 22.

The diameter of the fixing hole 28 of the counterpart is dimensioned to be somewhat greater than the diameter of the bolt 25. Further, a protrusion 30 of a shape of a circular cone is formed in the counterpart 23, around the bolthole 28, and the frame 22 is provided with a countersink of a substantially similar shape.

The bolt 25 is fixed to the threaded hole 27 at such a depth that the elastic part 29 is somewhat pressed, but yet in such a way that the elastic part 29 can be compressed even further, in other words it can be compressed in the longitudinal direction of the bolt 25 so that it even becomes shorter. Owing to the flexibility of the elastic part 29, the counterpart 23 can be inclined to some extent to either side relative to the frame 22. Now, when the lower support plate with its workpieces is lifted against the counterpart 23 of the upper support plate, which lower support plate is not, for some reason, parallel with the counterpart 23, the position of the counterpart 23 adapts to the position of the lower support plate. In other words, the lower and upper support plates 13, 14 need not be exactly parallel in order for the whole workpiece to be pressed evenly between them. Owing to the conical protrusion 30 and the countersink, the counterpart 23 always returns to the same position and location relative to the frame 22 after the lowering of the lower support plate 13. Preferably, each workpiece 6 located on the pallet 5 and thus to be lifted up from the pallet at a time has an upper support plate 14 of its own, which can change its position to conform to the position of its lower support plate pair, irrespective of the upper support plates fixed to the fixing member of the upper support plate.

The structure of the upper support plate 14 may also be such that there is no frame 22, but the counterpart 23 of the upper support plate is fixed directly to the fixing members 12 of the upper support plate. The elastic part 29 may also be a spring or the like reversibly compressible member. In the same way, the movement of the counterpart 23 relative to the frame 22 can be controlled not only with cone structures described here but also with guide tracks or the like.

The drawings and the related description are only intended to illustrate the idea of the invention. The details of the invention may vary within the scope of the claims. Thus, on the assembly line 1, the positioning units 4 of the assembly devices 2a, 2b, 2c may be different from each other.

1. A method of adjusting a modular assembly line, the assembly line comprising
at least one positioning unit, the positioning unit comprising
a fixing member of a lower support plate and a fixing member of an upper support plate, which are arranged movably relative to each other in such a way that the fixing member of the lower support plate is transferable to a first and a second distance relative to the fixing member of the upper support plate;
an actuator disposed in connection with the positioning unit, operating a tool used in the working step taking place in the positioning unit; and
conveyor means, which comprise pallets conveying workpieces, and a conveyor, the conveyor means conveying workpieces to the positioning unit and away from it;
the method comprising steps of:
manufacturing the fixing member of the lower support plate in such a way that the location of a workpiece-specific lower support plate is unambiguously determined in the fixing member in question;
manufacturing the fixing member of the upper support plate in such a way that the location of a workpiece-specific upper support plate is unambiguously determined in the fixing member in question;
aligning the fixing member of the lower support plate with the fixing member of the upper support plate and fixing said fixing members permanently to their places aligned in this manner;
aligning the conveyor means with said fixing members of the upper and lower support plates; and
fixing the coordinate system of the actuator and the coordinate system of the positioning unit to each other.

2. A method according to claim 1, further comprising the step of aligning the fixing member of the lower support plate with the fixing member of the upper support plate by using an auxiliary tool.

3. A method according to claim 2, wherein the auxiliary tool is an elongated form part and the fixing members comprising first and second alignment surfaces fitting the shape of the form part and disposed in such a way that when the auxiliary tool is arrangeable on both the first and the second alignment surfaces at the same time, the fixing members are aligned with each other.

4. A method according to claim 1, further comprising the step of aligning the conveyor means with the fixing members of said upper and lower support plates by means of an auxiliary pallet.

5. A method according to claim 4, further comprising the step of using in the alignment an auxiliary tool and the auxiliary pallet comprising third alignment surfaces in such a way that when the auxiliary tool is arrangeable both on the third alignment surfaces and the alignment surfaces of the fixing member at the same time, the conveyor means are aligned with said fixing members.

6. A method according to claim 1, further comprising the step of determining the distance between said first position and said second position unambiguously.

7. A method according to claim 1, further comprising the step of fixing the coordinate system of the intelligent actuator and the coordinate system of the positioning unit to each other by means of a teaching tool.

8. A positioning unit of a modular assembly line, comprising:
a frame, a fixing member of a lower support plate disposed in the frame, a fixing member of an upper support plate disposed in the frame and movably in direction X relative to the fixing member of the lower support plate in such a way that the fixing member of the lower support plate is transferable to a first and a second distance relative to the fixing member of the upper support plate;
fixing parts disposed in the fixing member of the lower support plate for fixing a product-specific lower support plate unambiguously to the fixing member;
fixing parts disposed in the fixing member of the upper support plate for fixing a product-specific upper support plate unambiguously in the fixing member, which fixing members of the lower support plate and upper support plate are disposed in the frame immovably in the directions perpendicular to direction X.

9. A positioning unit according to claim 8, wherein first and second alignment surfaces are arranged in the fixing members of the lower and/or upper support plate, on which alignment surfaces an auxiliary tool is arrangeable for aligning the conveyor means of the assembly line with the positioning unit.

10. A positioning unit according to claim 8, wherein the upper support plate is arranged to be flexibly fixed to the fixing member of the upper support plate in direction X.

11. A positioning unit according to claim 8, wherein the positioning unit comprises workpiece-specific support plates for at least two workpieces.

12. A computer program, which is loadable into the internal memory of a digital computer, wherein said computer program comprises a software code for teaching product-specific parameters to an intelligent actuator of a positioning unit in the coordinate system of the positioning unit provided by the method according to claim 1.

13. A computer program product, comprising a computer program according to claim 12.
